(19) United States
(12) Patent Application Publication
(10) Pub. No.: US 2024/0347255 A1
(43) Pub. Date: Oct. 17, 2024

(54) INDUCTOR AND METHOD FOR MANUFACTURING SAME

(71) Applicant: Panasonic Intellectual Property Management Co., Ltd., Osaka (JP)

(72) Inventors: TOMOHIRO SUGIMURA, Osaka (JP); YUYA ISHIDA, Shiga (JP); TOMOHIRO TSUBOTA, Fukui (JP); KOTARO AKIYAMA, Hyogo (JP); TAKUMI TANIKAWA, Hyogo (JP)

(21) Appl. No.: 18/701,275

(22) PCT Filed: Sep. 14, 2022
(86) PCT No.: PCT/JP2022/034358

§ 371 Date: Apr. 15, 2024

(30) Foreign Application Priority Data
Oct. 29, 2021 (JP) 2021-177061

(51) Int. Cl. H01F 17/04; H01F 3/08; H01F 27/29; H01F 41/02; H01F 41/066

(52) U.S. Cl. CPC H01F 17/04; H01F 3/08; H01F 27/292; H01F 41/0206; H01F 41/066

(57) ABSTRACT

An inductor includes a magnetic core, a coil element embedded in the magnetic core and including an end portion protruding from an end surface of the magnetic core, and an electrode electrically and mechanically connected to the end portion of the coil element. The electrode is bent along the end surface and a bottom surface of the magnetic core such that the electrode includes an end-surface portion facing the end surface of the magnetic core and a bottom-surface portion facing the bottom surface of the magnetic core. The end portion of the coil element is placed on the electrode to be connected to the electrode. The end surface of the magnetic core includes: a first region connected to the bottom surface of the magnetic core and having the inner surface of the electrode disposed thereon; and two second regions connected to the bottom surface of the magnetic core and located on both sides of the first region across the first region. An angle formed by the bottom surface of the magnetic core and each of the two second regions of the end surface of the magnetic core is less than 90.0° and is greater than an angle formed by the bottom surface of the magnetic core and the outer surface of the end-surface portion of the electrode.

### TECHNICAL FIELD

The present disclosure relates to inductors for use in various electronic devices and methods of manufacturing the same.

### BACKGROUND ART

As electronic devices have increasingly higher performance in recent years, demands for size reduction have increased and electric current used have also been increasing, so inductors that can satisfy both of these requirements have been sought. For this reason, an inductor has been proposed in which a magnetic core is formed by embedding a coil element in a mixture powder of metallic magnetic material powder and a binder agent composed of a thermosetting resin and compression-molding the material. Moreover, in order to reduce the cost of forming an external electrode, another inductor has been proposed that is manufactured by molding a component that later constitutes the external electrode at the same time as the formation of a magnetic core.

An inductor similar to the above-described inductors is disclosed in, e.g., PTL 1.

### CITATION LIST

### Patent Literature

PTL 1: Japanese Patent Laid-Open Publication No. 2005-294461

### SUMMARY

In a conventional inductor, if a component that later constitutes the external electrode is placed in a die and compression molded, the external electrode may be rubbed against a wall surface of the die when removing the molded material from the die, causing scratches in the external electrode. Scratches in the external electrode may provide problems in solderability.

An inductor includes a magnetic core, a coil element embedded in the magnetic core and including an end portion protruding from an end surface of the magnetic core, and an electrode electrically and mechanically connected to the end portion of the coil element. The electrode is bent along the end surface and a bottom surface of the magnetic core and includes an end-surface portion facing the end surface of the magnetic core and a bottom-surface portion facing the bottom surface of the magnetic core. The end portion of the coil element is placed on the electrode and connected to the electrode. The end surface of the magnetic core includes a first region and two second regions. The first region is connected to the bottom surface of the magnetic core and has the end-surface portion of the electrode disposed thereon. The two second regions are connected to the bottom surface of the magnetic core and located on both sides of the first region across the first region. An angle formed by the bottom surface of the magnetic core and each of the two second regions of the end surface of the magnetic core is less than 90.0° and is greater than an angle formed by the bottom surface of the magnetic core and an outer surface of the end-surface portion of the electrode.

This inductor has a small size, is capable of dealing with high power, and has preferable solderability.

### BRIEF DESCRIPTION OF THE DRAWINGS

FIG. 1 is a perspective view of an inductor according to an exemplary embodiment of the present disclosure.

FIG. 2 is a cross-sectional view of the inductor taken along line II-II shown in FIG. 1.

FIG. 3 is a cross-sectional view of the inductor according to the embodiment for illustrating a method of manufacturing of the inductor.

FIG. 4 is a cross-sectional view of the inductor according to the embodiment for illustrating the method of manufacturing of the inductor.

FIG. 5 is a cross-sectional view of the inductor according to the embodiment for illustrating the method of manufacturing of the inductor.

FIG. 6 is a cross-sectional view of the inductor according to the embodiment for illustrating the method of manufacturing of the inductor.

### DESCRIPTION OF EMBODIMENTS

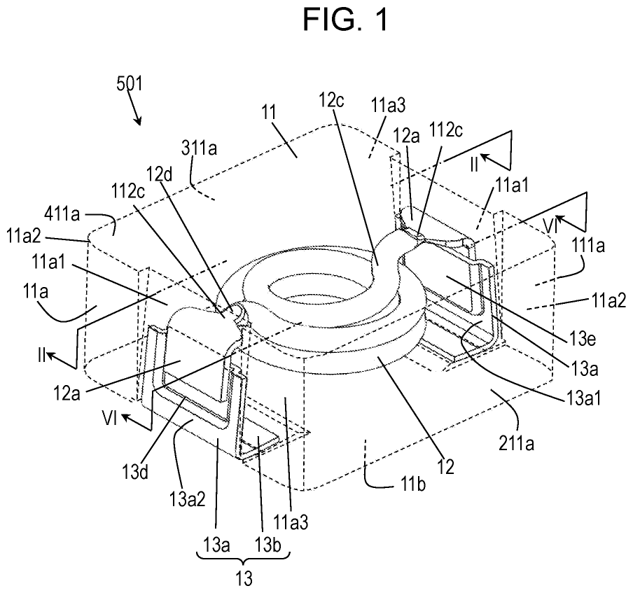

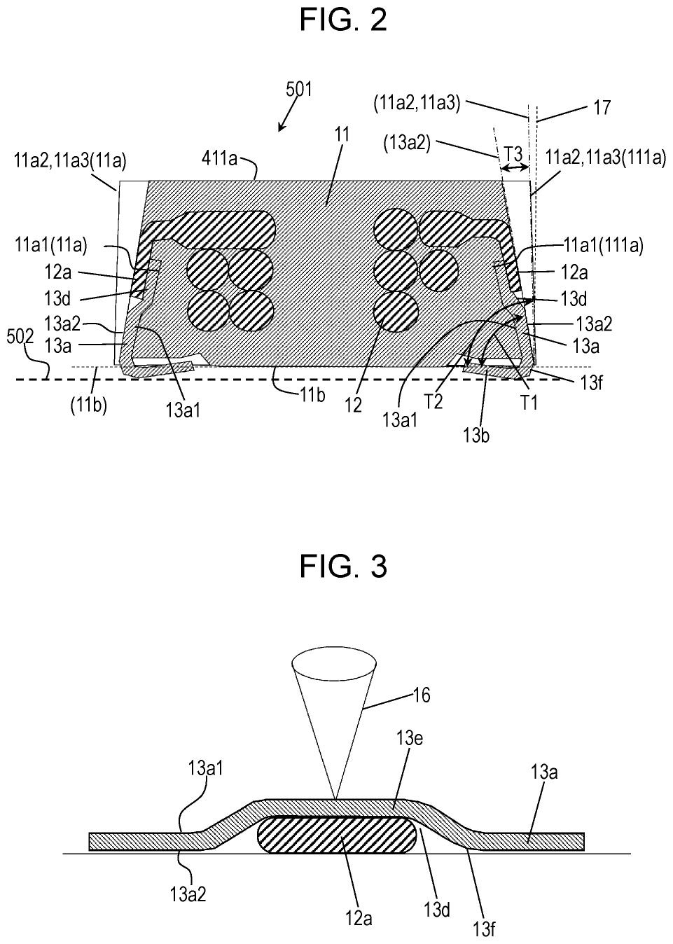

An inductor according to an exemplary embodiment of the present invention will be described below with reference to the drawings. FIG. 1 is a perspective view of inductor 501 according to an exemplary embodiment of the present disclosure. FIG. 2 is a cross-sectional view of inductor 501 taken along line II-II shown in FIG. 1. Inductor 501 includes magnetic core 11, coil element 12 embedded in magnetic core 11, and electrode 13 electrically and mechanically connected to coil element 12. For clarity, a contour portion of magnetic core 11 is shown as dashed lines in FIG. 1.

Coil element 12 is made of a wound insulator-coated conductive wire with a diameter of about 0.3 mm. A portion of insulation coating 12c located at end portion 12a of coil element 12 is peeled off, and end portion 12a is pressed have a flat shape with a thickness of about 0.2 mm. Magnetic core 11 is formed by embedding coil element 12 in a magnetic material powder mixture containing a magnetic material powder including a Fe—Si—Cr alloy mixed with a binder agent including silicone, and compression-molding the magnetic material powder mixture. Magnetic core 11 has a rectangular parallelepiped shape having a planar shape with about 10 mm square and a height of about 5 mm. Magnetic core 11 has bottom surface 11b, top surface 411a opposite to bottom surface 11b, end surfaces 11a, 111a, 211a, and 311a that are connected to bottom surface 11b and top surface 411a. End surfaces 11a and 111a are opposite to each other, and end surfaces 211a and 311a are opposite to each other. End portions 12a of coil element 12 protrude from end surfaces 11a of magnetic core 11, respectively. Electrode 13 is fixed onto end surface 11a (111a) of magnetic core 11 and is bent along bottom surface 11b of magnetic core 11. Electrode 13 includes end-surface portion 13a disposed on end surface 11a (111a) and extending along end surface 11a (111a), and has bottom-surface portion 13b disposed on bottom surface 11b and extending along bottom surface 11b.

At least a portion of end-surface portion 13a of electrode 13 located on end surface 11a in a thickness direction of electrode 13 is embedded in magnetic core 11 and fixed to magnetic core 11. End-surface portion 13a of electrode 13 has inner surface 13al facing magnetic core 11 and outer surface 13a2 opposite to inner surface 13al. Inner surface 13al of end-surface portion 13a contacts region 11al of end surface 11a (111a) of magnetic core 11. Outer surface 13a2 of end-surface portion 13a of electrode 13 has recess 13d therein that sinks toward magnetic core 11 to be put in magnetic core 11. End portion 12a of coil element 12 is placed on recess 13d and electrically and mechanically connected to electrode 13. A position of inner surface 13al of electrode 13 opposite to recess 13d deforms along the shape of recess 13d to provide protrusion 13e on inner surface 13al of electrode 13 Protrusion 13e is embedded further deeply into magnetic core 11 approximately by the thickness of end portion 12a of coil element 12. Protrusion 13e provided on inner surface 13al of electrode 13 that faces magnetic core 11 increases the adhesion strength of electrode 13 to magnetic core 11.

Electrode 13 is made by punching out a flat-shaped copper plate containing 99% or greater of copper, and has a thickness of about 0.15 mm. One surface (outer surface 13a2) of electrode 13 has plated layer 13f in which nickel and tin are plated in that order thereon, and the other surface (inner surface 13a1) that is opposite to the outer surface dos not have a plated layer to expose the copper. End portion 12a of coil element 12 is electrically and mechanically connected to outer surface 13a2 by welding end portion 12a to outer surface 13a2 of end-surface portion 13a of electrode 13 having plated layer 13f provided thereon and disposed on end surface 11a of magnetic core 11. Inner surface 13al of end-surface portion 13a of electrode 13 that does not have a plated layer thereon is embedded in magnetic core 11 to contact magnetic core 11. Plated layer 13f provided on outer surface 13a2 of end-surface portion 13a of electrode 13 is soldered easy. If a plated layer with a low melting point, such as tin, is on a portion of electrode 13 that is embedded in magnetic core 11, the plated layer may melt when, for example, reflow soldering, causing problems in reliability. In contrast, in inductor 501 according to the embodiment, the portion of electrode 13 having plated layer 13f thereon is not embedded in magnetic core 11, providing inductor 501 with high reliability.

Angle T1 formed by bottom surface 11b of magnetic core 11 and end-surface portion 13a of electrode 13 that is located on end surface 11a (111a) of magnetic core 11 is about 86.5°. In FIG. 2, an extension line of bottom surface 11b of magnetic core 11 is indicated by dashed line, and outer surface 13a2 of end-surface portion 13a of electrode 13 is indicated by dash-dotted line. Angle T2 formed by bottom surface 11b of magnetic core 11 and each of regions 11a2 and 11a3 which face each other across end-surface portion 13a of electrode 13, i.e., on both sides of region 11al of end surface 11a (111a) of magnetic core 11, is about 89.5°. Region 11al (111a) of end surface 11a of magnetic core 11 is located between regions 11a2 and 11a3. In FIG. 2, regions 11a2 and 11a3 of end surface 11a of magnetic core 11 are indicated by dash-dot-dot lines. A surface that serves as the reference as bottom surface 11b of magnetic core 11 means a flat surface on which magnetic core 11 is placed while bottom-surface portion 13b of electrode 13 that is located on bottom surface 11b of magnetic core 11 is removed. The reason why angle T2 formed by bottom surface 11b of magnetic core 11 and each of regions 11a2 and 11a3 of end surface 11a of magnetic core 11 that are on both sides of electrode 13 is about 89.5° which is less than 90.0° (indicated by dotted line 17 in FIG. 2) is to facilitate removing magnetic core 11 from the die used in compression-molding, so that regions 11a2 and 11a3 of end surface 11a are slightly sloped.

When magnetic core 11 is removed from the die after placed in the die and compression molded, magnetic core 11 as a whole tends to expand. End-surface portion 13a of electrode 13 that is disposed on end surface 11a (111a) of magnetic core 11 is consequently pressed against a wall of the die with strong stress force, causing end-surface portion 13a to be easily scratched. On the other hand, in accordance with the embodiment of the present invention, regions 11a2 and 11a3 of end surface 11a of magnetic core 11 that are on both sides of electrode 13 and on end surface 11a side of magnetic core 11 are at an angle closer to a right angle with respect to bottom surface 11b of magnetic core 11 than end-surface portion 13a of electrode 13. Therefore, even if magnetic core 11 as a whole expands, regions 11a2 and 11a3 of end surface 11a of magnetic core 11 that are on both sides of electrode 13 and on end surface 11a side of magnetic core 11 serve as supports, to reduce expansion of outer surface 13a2 of the end-surface portion of electrode 13. As a result, end-surface portion 13a of electrode 13 that is on end surface 11a side of magnetic core 11 is unlikely to be scratched. Since outer surface 13a2 of end-surface portion 13a of electrode 13 has a larger slope than regions 11a2 and 11a3 of end surface 11a of magnetic core 11 that are on both sides of electrode 13, the pressure acting to spread magnetic core 11 in directions toward end surfaces 11a during compression-molding is distributed along the slope, so that the expansion of magnetic core 11 as a whole can be reduced.

Angle T3 (=T2−T1) formed by outer surface 13a2 of end-surface portion 13a of electrode 13 and each of regions 11a2 (11a3) of end surface 11a of magnetic core 11 that are on both sides of electrode 13 is preferably 2.0° or more and 5.0° or less. Angle T3 less than 2.0° may unpreferably reduce the effect of reducing scratches in electrode 13. Angle T3 greater than 5.0° may unpreferably cause cracks in magnetic core 11 when bending electrode 13 from end surface 11a of magnetic core 11 toward bottom surface 11b of magnetic core 11.

Inductor 501 is configured to be mounted on mounting surface 502 that faces bottom surface 11b of magnetic core 11. Since end-surface portion 13a of electrode 13 is forward tapered with respect to mounting surface 502, solder easily expands and wet upward on end-surface portion 13a of electrode 13 when mounting and soldering inductor 501, and also, soldering conditions are easily checked from above.

As described above, magnetic core 11 contains magnetic material powder and binder agent mixed in the magnetic material powder, and has bottom surface 11b and end surface 11a (111a) connected to bottom surface 11b. Coil element 12 is embedded in magnetic core 11 and includes end portion 12a protruding from end surface 11a of magnetic core 11. Electrode 13 is electrically and mechanically connected to end portion 12a of coil element 12. Electrode 13 is bent along end surface 11a and bottom surface 11b of magnetic core 11 and includes end-surface portion 13a facing end surface 11a of magnetic core 11 and bottom-surface portion 13b facing bottom surface 11b of magnetic core 11. End-surface portion 13a of electrode 13 includes inner surface 13al facing magnetic core 11 and outer surface 13a2 opposite to inner surface 13al. Outer surface 13a2 of end-surface portion 13a of electrode 13 has recess 13d therein that sinks toward magnetic core 11. End portion 12a of coil element 12 is placed on recess 13d of electrode 13 and to be connected to electrode 13. Inner surface 13al of end-surface portion 13a of electrode 13 is embedded in magnetic core 11. End surface 11a of magnetic core 11 includes region 11al and two regions 11a2 and 11a3. Region 11al is connected to bottom surface 11b of magnetic core 11 and has inner surface 13al of electrode 13 disposed thereon. Two regions 11a2 and 11a3 are connected to bottom surface 11b of magnetic core 11 and located on both sides of region 11al across region 11a1. Angle T2 formed by bottom surface 11b of magnetic core 11 and each of two regions 11a2 and 11a3 of end surface 11a of magnetic core 11 is less than 90.0° and is greater than angle T1 formed by bottom surface 11b of magnetic core 11 and outer surface 13a2 of end-surface portion 13a of electrode 13.

Angle T3 formed by outer surface 13a2 of end-surface portion 13a of electrode 13 and two regions 11a2 and 11a3 of end surface 11a of magnetic core 11 may be 2.0° or more and 5.0° or less.

Inner surface 13al of end-surface portion 13a of electrode 13 may have thereon protrusion 13e located opposite to recess 13d and protruding toward magnetic core 11.

Electrode 13 may further include plated layer 13f disposed at a surface (outer surface 13a2) of electrode 13 that does not face magnetic core 11. In this case, the surface (inner surface 13a1) of electrode 13 that faces magnetic core 11 may not have a plated layer thereon.

A method of manufacturing inductor 501 will be described below. FIGS. 3-6 are cross-sectional views of inductor 501 according to the embodiment for illustrating the method of manufacturing inductor 501.

First, conductive wire 12d having insulation coating 12c thereon is wound spirally. Opposite end portions 12a are drawn in directions opposite to each other, thereby providing coil element 12. An insulator-coated copper wire with a diameter of about 0.3 mm is used for conductive wire 12d. A portion of insulation coating 12c that is located at end portion 12a of coil element 12 is peeled off, and end portion 12a is pressed to have a flat shape with a thickness of about 0.2 mm.

One surface of a copper plate containing 99% of copper is plated with nickel and tin to form plated layer 13f thereon. Then, the flat plate with plated layer 13f is punched out to obtain electrode 13. Electrode 13 includes end-surface portion 13a, bottom-surface portion 13b, and end-surface portion 13a. End-surface portion 13a is a portion configured to be disposed on end surface 11a of magnetic core 11 and connected to end portion 12a of the coil element. Bottom-surface portion 13b is a portion connected to end-surface portion 13a and is configured to be disposed on bottom surface 11b of magnetic core 11. Support portion 13c is connected to bottom-surface portion 13b opposite to end-surface portion 13a and is supported by a die when compression-molding magnetic core 11 as described later. The thickness of electrode 13 is about 0.15 mm.

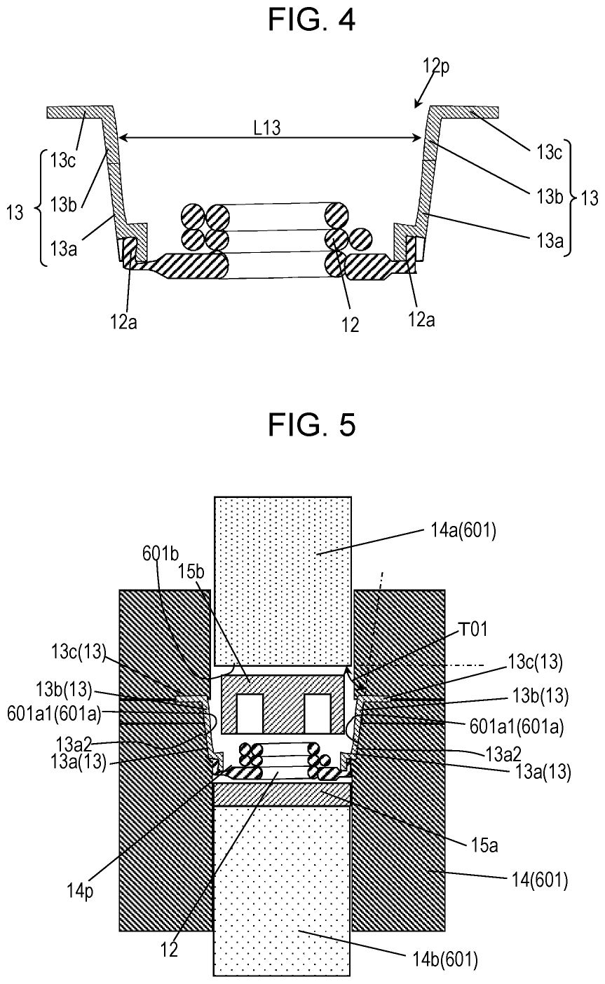

Next, end portion 12a of coil element 12 is welded and electrically and mechanically connected to electrode 13 by, e.g., laser welding to form coil assembly 12p. FIG. 4 shows a cross section of coil assembly 12p. Recess 13d is previously provided by pressing end-surface portion 13a of electrode 13 on which end portion 12a of coil element 12 is configured to be placed. End portion 12a of coil element 12 is preferably accommodated in recess 13d and welded to recess 13d. Protrusion 13e deforming along the shape of recess 13d is provided on inner surface 13al of electrode 13 opposite to recess 13d faces magnetic core 11.

An example of the welding is as follows. As illustrated in FIG. 3, for example, recess 13d with a depth of about 0.15 mm is provided in outer surface 13a2 provided with plated layer 13f. End portion 12a of coil element 12 is placed on recess 13d of electrode 13. Then, laser 16 is applied to inner surface 13al of electrode 13 on which plated layer 13f is not provided. Heat generated by laser 16 is transferred to outer surface 13a2 on the opposite side to melt plated layer 13f to thereby cause electrode 13 securely contact end portion 12a of coil element 12, so that heat is transferred to end portion 12a of coil element 12 to weld end portion 12a of coil element 12 to electrode 13.

Next, a step of bending end portion 12a of coil element 12 and electrode 13 is performed. In this step, preparation is performed to place coil element 12 and end-surface portion 13a of electrode 13 of coil assembly 12p including coil element 12 and electrode 13 which are connected unitarily to each other into a cavity of a die for compression-molding magnetic core 11 described later. A condition of coil assembly 12p when compression-molding magnetic core 11 is as follows. As illustrated in FIG. 4, electrode 13 is bent at end portion 12a of coil element 12, end-surface portion 13a and bottom-surface portion 13b have planer shapes, and support portion 13c is bent outward with respect to coil element 12 so as to be away from coil element 12.

Preparation is performed to form magnetic core 11. First, pressed magnetic powder made of a mixture of magnetic material powder made of Fe—Si—Cr alloy and binder agent made of silicone is placed in a tablet die and compressed with a pressure of about 0.25 tons/cm², thereby providing a magnetic powder tablet configured to easily break due to pressure. In accordance with the embodiment, a lower magnetic powder tablet for forming a lower portion of magnetic core 11 and an upper magnetic powder tablet for forming an upper portion of magnetic core 11 are prepared. The shape of the lower magnetic powder tablet may preferably have a recess with a cylindrical shape therein for accommodating coil element 12 therein to have a pot shape with a cross section with an E-shape. The shape of the upper magnetic powder tablet may preferably have a flat plate shape so as to close the recess of the lower magnetic powder tablet.

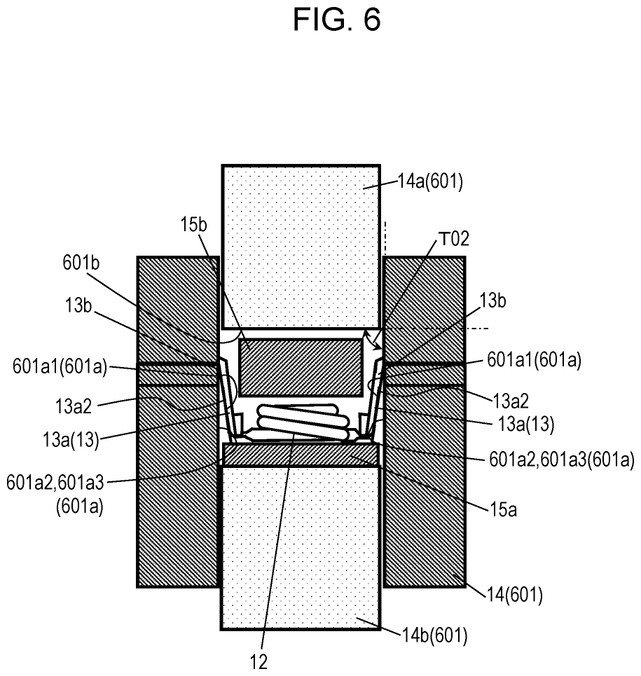

Next, magnetic core 11 is compression-molded. FIGS. 5 and 6 are cross-sectional views of inductor 501 for illustrating the method of manufacturing inductor 501. Die 14 with cavity 14p provided therein and upper punch 14a and lower punch 14b both configured to be inserted into cavity 14p together constitute die 601 for compression-molding magnetic core 11. FIGS. 5 and 6 schematically illustrate the inductor at a stage before upper magnetic powder tablet 15a, coil assembly 12p, and lower magnetic powder tablet 15b are placed into cavity 14p of die 14 and compression-molded. FIG. 5 corresponds to the cross section of inductor 501 shown in FIG. 2 taken along line II-II shown in FIG. 1. FIG. 6 corresponds to the cross section of inductor 501 taken along line VI-VI shown in FIG. 1.

As illustrated in FIGS. 5 and 6, upper magnetic powder tablet 15a is placed into cavity 14p of die 14, then, coil assembly 12p is placed on top of the tablet, and then, lower magnetic powder tablet 15b is placed in the cavity. Then, upper punch 14a is moved downward, and lower punch 14b is raised upward, thereby compressing magnetic powder tablets 15a and 15b with a pressure of about 4 tons/cm² to mold the magnetic powder tablets. After the compressing is completed, magnetic core 11 is formed in cavity 14p of die 14, and bottom-surface portion 13b and support portion 13c of electrode 13 are located outside magnetic core 11 (cavity 14p of die 14). Coil element 12 supported at support portion 13c of electrode 13 by die 14 during the compression-molding prevents misalignment while magnetic powder tablets 15a and 15b are compression-molded. For the method of placing lower magnetic powder tablet 15b into die 14, lower magnetic powder tablet 15b may be placed into die 14 after placing coil assembly 12p into die 14. Alternatively, lower magnetic powder tablet 15b may be placed into die 14 with lower magnetic powder tablet 15b attached to coil assembly 12p.

In a portion of inner wall surface 601a of die 14 for forming end surface 11a side of magnetic core 11, as illustrated in FIG. 5, angle T01 formed by inner wall surface 601b of upper punch 14a (die 601) for forming bottom surface 11b of magnetic core 11 and portion 601al of inner wall surface 601a of die 14 configured to contact outer surface 13a2 of end-surface portion 13a of electrode 13 is about 86.5°. As illustrated in FIG. 6, angle T2 formed by inner wall surface 601b of upper punch 14a (die 601) for forming bottom surface 11b of magnetic core 11 and each of portions 601a2 and 601a3 of inner wall surface 601a of die 14 for forming both sides of end-surface portion 13a of electrode 13 is about 89.5°. Thus, the slope of portion 601al of inner wall surface 601a of die 14 configured to contact end-surface portion 13a of electrode 13 with respect to inner wall surface 601b is different from the slope of each of inner wall surfaces 601b of portions 601a2 and 601a3 of inner wall surface 601a of die 14 for forming regions 11a2 and 11a3 of end surface 11a of magnetic core 11 that are on both sides of electrode 13. In this configuration, even when the entirety of magnetic core 11 tends to expand during the removing of magnetic core 11 after compression-molding, the portions of the inner wall surface of die 14 that are on both sides of end-surface portion 13a of electrode 13 support outer surface 13a2 of end-surface portion 13a of electrode 13, thereby preventing the expansion of outer surface 13a2 of end-surface portion 13a of electrode 13. As a result, end-surface portion 13a of electrode 13 that is on end surface 11a side of magnetic core 11 is unlikely to be scratched.

Furthermore, Since the position of end-surface portion 13a of electrode 13 is determined by die 14, the shape of inductor 501 becomes stable. Therefore, soldering can be performed stably when mounting and soldering inductor 501.

When placing coil assembly 12p including coil element 12 and electrode 13 unitarily assembled together into cavity 14p of die 14, coil assembly 12p may deform to reduce distance L13 between end-surface portions 13a of electrode 13 when inserting coil assembly 12p into cavity 14p, and then, lower magnetic powder tablet 15b may be placed into cavity 14p while widening distance L13 between end-surface portions 13a of electrode 13 so as to allow outer surface 13a2 of end-surface portion 13a to contact the inner wall surface portion of die 14. Then, compression-molding may be performed. This configuration prevents end-surface portion 13a of electrode 13 from being rubbed against inner wall surface 601a of die 14 when inserting the integrated part of coil element 12 and electrode 13 into die 14, preventing scratches on electrode 13.

After magnetic core 11 that has been compression-molded is removed from die 14, magnetic core 11 is thermally hardened, support portion 13c of electrode 13 is cut away, and bottom-surface portion 13b is bent, thereby providing inductor 501.

As described above, coil assembly 12p is prepared. Coil assembly 12p includes coil element 12 including opposite end portions 12a that are drawn out in directions opposite to each other, and further includes electrodes 13 electrically and mechanically connected to end portions 12a of coil element 12, respectively. Electrode 13 includes end-surface portion 13a electrically and mechanically connected to end portion 12a of coil element 12, and bottom-surface portion 13b connected to end-surface portion 13a. Magnetic powder tablet 15a containing magnetic material powder and resin mixed with the magnetic material powder is prepared. Magnetic powder tablet 15a and coil assembly 12p are placed in die 601. Magnetic core 11 is formed by compression-molding magnetic powder tablet 15a while magnetic powder tablet 15a and coil assembly 12p is placed in die 601. Bottom-surface portion 13b of electrode 13 and bottom-surface portion 13b of another electrode 13 are bent. Magnetic core 11 has bottom surface 11b, end surface 11a connected to bottom surface 11b, and end surface 111a disposed opposite to end surface 11a and connected to bottom surface 11b. End surface 11a of magnetic core 11 includes region 11al connected to bottom surface 11b of magnetic core 11 and two regions 11a2 and 11a3 which are connected to bottom surface 11b of magnetic core 11 and located on both sides of region 11al across region 11a1. Inner surface 13al of end-surface portion 13a of electrode 13 is disposed on region 11a1. End surface 111a of magnetic core 11 includes region 11al connected to bottom surface 11b of magnetic core 11 and two regions 11a2 and 11a3, which are connected to bottom surface 11b of magnetic core 11 and located on both sides of region 11al across region 11al. Inner surface 13al of end-surface portion 13a of electrode 13 is disposed on region 11al. When forming magnetic core 11, inner wall surface 601a of die 601 contacts outer surface 13a2 of end-surface portion 13a of electrode 13 and two regions 11a2 and 11a3 of end surface 11a of magnetic core 11, and inner wall surface 601a of die 601 contacts outer surface 13a2 of end-surface portion 13a of electrode 13 and two regions 11a2 of end surface 111a of magnetic core 11. In order that angle T2 formed by bottom surface 11b of magnetic core 11 and each of two regions 11a2 and 11a3 of end surface 11a of magnetic core 11 is less than 90.0° and greater than angle T1 formed by bottom surface 11b of magnetic core 11 and outer surface 13a2 of end-surface portion 13a of electrode 13, the slope of portion 601al (see FIG. 5) of inner wall surface 601a of die 601 configured to contact outer surface 13a2 of end-surface portion 13a of electrode 13 when forming magnetic core 11 is different from the slope of portions 601a2 and 601a3 (see FIG. 6) of inner wall surface 601a of die 601 configured to contact two regions 11a2 and 11a3 of end surface 11a of magnetic core 11 when forming magnetic core 11. In order that angle T2 formed by bottom surface 11b of magnetic core 11 and each of two regions 11a2 of end surface 111a of magnetic core 11 is less than 90.0° and greater than angle T1 formed by bottom surface 11b of magnetic core 11 and outer surface 13a2 of end-surface portion 13a of electrode 13, the slope of portion 601al of inner wall surface 601a of die 601 configured to contact outer surface 13a2 of end-surface portion 13a of electrode 13 when forming magnetic core 11 is different from the slope of portions 601a2 and 601a3 of inner wall surface 601a of die 601 configured to contact two regions 11a2 of end surface 11a of magnetic core 11 when forming magnetic core 11, thereby providing inductor 501.

When coil assembly 12p and electrode 13 are placed in die 601, coil assembly 12p may deform and be placed in die 601 while reducing distance L13 between end-surface portion 13a and end-surface portion 13a of electrode 13, and then, distance L13 between end-surface portion 13a and end-surface portion 13a of electrode 13 may be widened while the coil assembly 12p is placed in die 601 so as to allow end-surface portion 13a and end-surface portion 13a to contact inner wall surface 601a and inner wall surface 601a of die 601, respectively.

Magnetic powder tablet 15a containing magnetic material powder and resin may be further prepared. When forming magnetic core 11, magnetic powder tablet 15a and magnetic powder tablet 15b may be compression-molded with magnetic powder tablet 15a, magnetic powder tablet 15b, and coil assembly 12p which are placed in die 601, thereby forming magnetic core 11.

The step of placing coil assembly 12p into die 601 may be performed after the step of placing magnetic powder tablet 15a into die 601. The step of placing magnetic powder tablet 15b into die 601 may be performed after the step of placing coil assembly 12p into die 601.

Coil assembly 12p may be prepared as follows. Conductive wire 12d having a surface with insulation coating 12c thereon is winded spirally. Opposite ends of conductive wire 12d are drawn out in directions opposite to each other, and portions of conductive wire 12d that are located at the opposite ends of conductive wire 12d are peeled off, thereby providing coil element 12.

When preparing coil assembly 12p, end portion 12a of coil element 12 and electrode 13 may be bent.

Electrode 13 may further include support portion 13c connected to bottom-surface portion 13b. In this case, support portion 13c of electrode 13 may be cut away from bottom-surface portion 13b after forming magnetic core 11 and before bending bottom-surface portion 13b of electrode 13.

Magnetic powder tablet 15a (15b) may be compression-molded while support portion 13c of electrode 13 is supported, thereby forming magnetic core 11.

In the above-described case, magnetic powder tablet 15a (15b) may be compression-molded while support portion 13c of electrode 13 is supported by die 601, thereby forming magnetic core 11.

### INDUSTRIAL APPLICABILITY

An inductor according to the present disclosure is unlikely to be scratched in an electrode and has excellent solderability even if a magnetic core is compression-molded with the electrode placed in a die, and is therefore industrially useful.

### REFERENCE MARKS IN THE DRAWINGS

11 magnetic core
12 coil element
12a end portion of coil element (first end portion, second end portion)
12c insulation coating
12d conductive wire
12p coil assembly
13 electrode
13a end-surface portion
13b bottom-surface portion
13c support portion
13d recess
13e protrusion
13f plated layer
14 die
14a upper punch (die)
14b lower punch (die)
14p cavity
15a upper magnetic powder tablet (first magnetic powder tablet)
15b lower magnetic powder tablet (second magnetic powder tablet)
16 laser light
501 inductor
601 die

1. An inductor comprising:
a magnetic core containing magnetic material powder and binder agent mixed with the magnetic material powder, the magnetic core having a bottom surface and an end surface connected to the bottom surface;
a coil element embedded in the magnetic core, the coil element including an end portion protruding from the end surface of the magnetic core; and
an electrode electrically and mechanically connected to the end portion of the coil element, wherein:
the electrode is bent along the end surface and the bottom surface of the magnetic core such that the electrode includes an end-surface portion facing the end surface of the magnetic core and a bottom-surface portion facing the bottom surface of the magnetic core,
the end-surface portion of the electrode has an inner surface facing the magnetic core and an outer surface opposite to the inner surface,
the outer surface of the end-surface portion of the electrode has a recess therein that sinks toward the magnetic core,
the end portion of the coil element is placed on the recess of the electrode to be connected to the electrode,
the inner surface of the end-surface portion of the electrode is embedded in the magnetic core,
the end surface of the magnetic core includes:
a first region connected to the bottom surface of the magnetic core, the inner surface of the electrode being disposed on the first region; and
two second regions connected to the bottom surface of the magnetic core and located on both sides of the first region across the first region, and
an angle formed by the bottom surface of the magnetic core and each of the two second regions of the end surface of the magnetic core is less than 90.0° and is greater than an angle formed by the bottom surface of the magnetic core and the outer surface of the end-surface portion of the electrode.

2. The inductor according to claim 1, wherein an angle formed by the outer surface of the end-surface portion of the electrode and each of the two second regions of the end surface of the magnetic core is 2.0° or more and 5.0° or less.

3. The inductor according to claim 1, wherein the inner surface of the end-surface portion of the electrode includes a protrusion located opposite to the recess and protruding toward the magnetic core.

4. The inductor according to claim 1, wherein:
the electrode further includes a plated layer disposed at a surface of the electrode that does not face the magnetic core, and
a plated layer is not provided at a surface of the electrode that faces the magnetic core.

5. A method of manufacturing an inductor, comprising:
providing a coil assembly which includes:
a coil element including a first end portion and a second end portion which are drawn out in directions opposite to each other,
a first electrode including a first end-surface portion and a first bottom-surface portion connected to the first end-surface portion, the first end-surface portion being electrically and mechanically connected to the first end portion of the coil element, and
a second electrode including a second end-surface portion and a second bottom-surface portion connected to the first end-surface portion, the second end-surface portion being electrically and mechanically connected to the second end portion of the coil element;
providing a first magnetic powder tablet containing magnetic material powder and resin mixed with the magnetic material powder;
placing the first magnetic powder tablet and the coil assembly into a die;
forming a magnetic core by compression-molding the first magnetic powder tablet while the first magnetic powder tablet and the coil assembly are placed in the die; and
bending the first bottom-surface portion of the first electrode and the second bottom-surface portion of the second electrode, wherein
the magnetic core has a bottom surface, a first end surface connected to the bottom surface, and a second end surface connected to the bottom surface at an opposite side to the first end surface,
the first end surface of the magnetic core includes:
a first region connected to the bottom surface of the magnetic core, an inner surface of the first end-surface portion of the first electrode being disposed on the first region; and
two second regions connected to the bottom surface of the magnetic core and located on both sides of the first region across the first region;
the second end surface of the magnetic core includes:
a third region connected to the bottom surface of the magnetic core, an inner surface of the second end-surface portion of the second electrode being disposed on the third region; and
two fourth regions connected to the bottom surface of the magnetic core and located on both sides of the third region across the third region,
in said forming the magnetic core, a first inner wall surface of the die contacts an outer surface of the first end-surface portion of the first electrode and the two second regions of the first end surface of the magnetic core, and a second inner wall surface of the die contacts an outer surface of the second end-surface portion of the second electrode and the two fourth regions of the second end surface of the magnetic core,
a slope of a portion of the first inner wall surface of the die that contacts the outer surface of the first end-surface portion of the first electrode in said forming the magnetic core is different from a slope of portions of the first inner wall surface of the die that contact the two second regions of the first end surface of the magnetic core in said forming the magnetic core, such that an angle formed by the bottom surface of the magnetic core and each of the two second regions of the first end surface of the magnetic core is less than 90.0° and is greater than an angle formed by the bottom surface of the magnetic core and the outer surface of the first end-surface portion of the first electrode, and
a slope of a portion of the second inner wall surface of the die that contacts the outer surface of the second end-surface portion of the second electrode in said forming the magnetic core is different from a slope of portions of the second inner wall surface of the die that contact the two fourth regions of the second end surface of the magnetic core in said forming the magnetic core, such that an angle formed by the bottom surface of the magnetic core and each of the two fourth regions of the second end surface of the magnetic core is less than 90.0° and is greater than an angle formed by the bottom surface of the magnetic core and the outer surface of the second end-surface portion of the second electrode.

6. The method according to claim 5, wherein said placing the coil assembly into the die the comprises:
placing the coil assembly into the die by deforming the coil assembly so as to reduce a distance between the first end-surface portion of the first electrode and the second end-surface portion of the second electrode; and
then causing the first end-surface portion and the second end-surface portion to contact the first inner wall surface and the second inner wall surface of the die, respectively by widening the distance between the first end-surface portion of the first electrode and the second end-surface portion of the second electrode while the coil assembly is placed in the die, and causing the first end-surface portion and the second end-surface portion to contact the first inner wall surface and the second inner wall surface of the die, respectively.

7. The method according to claim 5, further comprising:
providing a second magnetic powder tablet containing magnetic material powder and resin; and
placing the second magnetic powder tablet into the die; wherein
said forming the magnetic core comprises forming the magnetic core by compression-molding the first magnetic powder tablet and the second magnetic powder tablet while the first magnetic powder tablet, the second magnetic powder tablet, and the coil assembly are placed in the die.

8. The method according to claim 7, wherein
said placing the coil assembly into the die is performed after said placing the first magnetic powder tablet into the die, and
said placing the second magnetic powder tablet into the die is performed after said placing the coil assembly into the die.

9. The method according to claim 5, wherein said providing the coil assembly comprises:
spirally winding a conductive wire having a surface provided with an insulation coating; and
forming the coil element by drawing both ends of the conductive wire in directions opposite to each other and peeling off portions of the insulation coating located at the both ends of the conductive wire.

10. The method according to claim 5, wherein said providing the coil assembly comprises bending the first end portion and the second end portion of the coil element, the first electrode, and the second electrode.

11. The method according to claim 5, wherein
in said providing the coil assembly, the first electrode further includes a first support portion connected to the first bottom-surface portion, and
in said providing the coil assembly, the second electrode further includes a second support portion connected to the second bottom-surface portion, and
the method further comprises cutting away the first support portion of the first electrode and the second support portion of the second electrode from the first bottom-surface portion and the second bottom-surface portion, respectively, after said forming the magnetic core and before said bending the first bottom-surface portion of the first electrode and the second bottom-surface portion of the second electrode.

12. The method according to claim 11, wherein said forming the magnetic core comprises forming the magnetic core by compression-molding the first magnetic powder tablet while supporting the first support portion of the first electrode and the second support portion of the second electrode.

13. The method according to claim 12, wherein said forming the magnetic core comprises forming the magnetic core by compression-molding the first magnetic powder tablet while the first support portion of the first electrode and the second support portion of the second electrode are supported by the die.
